(19) United States
(12) Patent Application Publication
(10) Pub. No.: US 2008/0305919 A1
(43) Pub. Date: Dec. 11, 2008

(54) Friction Gear Frej

(76) Inventor: Gustav Rennerfelt, Lidingo (SE)

Correspondence Address: DICKSTEIN SHAPIRO LLP, 1825 EYE STREET NW, Washington, DC, 20006-5403, US

(21) Appl. No.: 12/158,924

(22) PCT Filed: Jan. 12, 2007
(86) PCT No.: PCT/SE2007/000022

§ 371 Date: Jun. 23, 2008

(30) Foreign Application Priority Data
Jan. 16, 2006 (SE) 0600075-6

(51) Int. Cl. F16H 13/08

(52) U.S. Cl. 476/36

(57) ABSTRACT

Actuators for adjustments of office and assembling work tables, hospital beds, windows, process valves are some examples on applications where the current gear technology gives noise problems and needs space. Friction gears give silent running but are sensitive for alignment errors of the output shaft. These errors give changes in the gear geometry which cause micro slip and bad efficiency and shorten the gear life time. This friction gear invention is unsensitive for alignment error of the output shaft. The theoretical optimal gear geometry is maintained even when the screw is oscillating during running. FIG. 3a shows a well known gear principle. FIG. 3b shows how “micro slip” will occur when the output shaft, to which the screw is fitted, is tilted for example 2 degrees. FIG. 3c shows the gear according to the invention where the stationary raceway is spherical and all other moving gear components are following the output shaft aiming (here 2 degrees from the symmetry axis of the gear) around the point C1 which is centre to the stationary spherical raceway. The flexibility of the raceways gives an even load distribution over all balls. The tolerance demand at the raceways will then decrease and the gear life time will increase.

The technology area of the innovation.

The innovation concerns a silent running slipfree friction gear with high efficiency.

The back ground for the invention and the current used technology.

The reason for this invention is the demand to use a mechanism which will in a silent and cheap way create a linear force which can move a mass forward and backwards both with short and long strokes. The outer load can be the friction, gravitation or a spring. This mechanism, further on called actuator, should have the smallest possible volume.

Examples of actuators applications are vertical movable office tables and assembling work tables, hospitals beds, remote control of windows and car chairs, backlash free control of valves and much more. The demand of low noise and low manufacturing costs is often very important.

In these types of applications the motor with reduction gear box is fitted to a screw with a nut. The nut is fitted to the object which should me moved. Very often it is difficult to create a straight linear movement. The nut is forced also to move in a perpendicular plane to the main moving direction. Also alignement errors occur.

Conventional actuators consist of a motor with a reduction gear box which is fitted to a helical threaded screw which is fitted to a stationary thrust bearing. At the rotation of the screw a nut (often made by plastic) is feeded forward and backwards.

The motor is often a DC (direct current) motor with commutating brushes, further on called brush motor, but a quite clear trend is that the prices of brushless motors with electronic commutation are decreasing and then more common. Alternative motor types are step motors, asyncronus and syncronus motors.

The normal reduction ratio in the gear box is in the range of 8:1-20:1. The ratio is often depending on that the helical screw should be self-locking, i.e. the outer axial load should not be able to rotate the actuator backwards if the motor power is broken. The limit for self-locking is about 8 degrees pitch angle. The efficiency of the screw increase with increasing pitch. For that reason you get the optimal pitch angle will be just close to 8 degrees. The lower pitch limit is depending on practical manufacturing reasons. With an axial pitch of smaller than 3 mm you have to leave the hexagon thread and instead use a normal thread profile which have still lower efficiency.

The gear box is often of worm gear type because it will give a silent running. The draw back is the bad efficiency, maximum 60% within the ratio 8:1-20:1. A serious draw back is also that motor/gear is angled to each other which create a bulky design.

To have a “straight” design, i.e. the motor, gear and screw are in line.

A planetary gear gives a straight design, but then the noise is a problem. Besides that in practice it is not possible to get more than about 8:1 in one gear step. You have to use two steps which will make it more complicated (expensive). The alternative is to use a bigger motor with higher torque which gives a clumsy design.

In the process industry well known Oden Gear gives a compact and simple design and a relative silent running. This is an excellent choice when the reduction ratio in the range 20:1 and higher. In these above mentioned applications the used range is 8:1-20:1.

There are planetary gears which do not use cog-gears but is friction gears. These are very silent but the drawback is that sliding may occur. To avoid that a spring pre-load is used which is dimensioned to meet the highest occurring load.

There are designs which have, besides a light basic pre-load, a torque coupling which gives a pre-load proportional to the load torque. This coupling consists of normally of some hardened steel balls placed in v-shaped grooves placed in radial direction to the output shaft. When the torque load increases the balls moves along the groove flanks and gives a higher axial pre-load.

The gear turns a screw which is fitted to a thrust bearing in the gear box.

Some well known friction gear principles.

The reason for that friction gears so far have been used relative little is the problem to avoid slipping and the bad efficiency.

A slipping reduces the life time dramatically and increases the sound level.

The total efficiency has often been far lower compared to the theoretical calculations.

The power loss for a hardened ball which rolls along a hardened and lubricated raceway is theoretically very low.

In a friction gear a lot of balls are used. To get this theoretical high efficiency the gear geometry has to correspond close to the theoretical model.

Relative small tolerances at the gear parts as well as outer loads will change the geometry which cause that the balls for example are running at individual different radius. This will create big friction forces between the balls and “micro-slip” occur, i.e. the balls are also partly sliding at the raceways. This sliding will very quickly harm the balls and the raceways.

An equal load distribution over all balls is also of great importance to transmit optimal high torque and increase the fatigue life time of the gear.

Even microscopic small surface defects will give high sound level and life time.

Sliding and then bad efficiency may occur of different reasons as:
1. Outer torque loads exceed the maximum torque load as the built in spring pre-load allows.
2. Outer loads create small position and load changes between the raceways and the rolling bodies in the gear.
3. Bad load distribution over the rolling bodies in the gear depending on mechanical tolerances at the gear components.

To be able to transmit optimal high torque in a ball friction gear, a spring pre-load or an outer load creates a surface pressure between each ball and raceway which gives a suitable high fatigue stress which gives an acceptable life time.

The Hertz elastic deformation in the contact points is then in a range of 0.00°-0.005 mm. You then realise that even very small geometrical error will cause sliding.

To add a coupling which are torque depending, i.e. gives a pre-load which is proportional to the torque load is possible. In friction gears with a fix reduction ratio such coupling will often be too expensive. In gears with stepless changeable reduction such technology is used. Examples of such friction gears are the Brottby variator and the Kopp variator.

This invention concerns a ball friction gear with fix ratio.

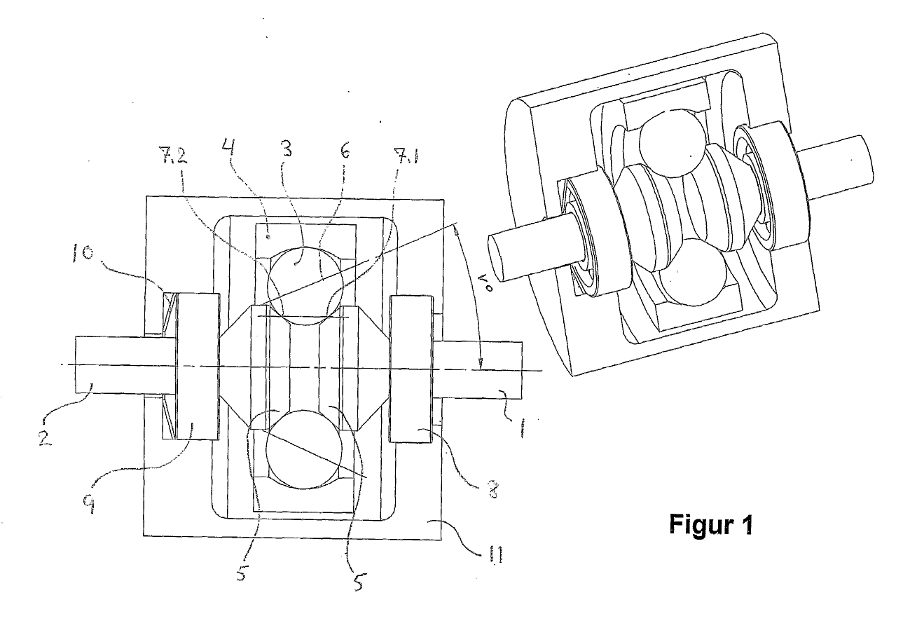

FIG. 1 shows a first partly sectioned well known ball friction gear principle which works as: The gear has an input shaft 1 and an output shaft 2. These shafts, which are identical have raceways 5 at which some balls 3, minimum 3 pcs. are running. The balls 3 are also running at a ring 4. The shafts 1 and 2 are pressed with a force in direction against each other by a spring 10 and ball bearing 9. In the house 11 there is a second ball bearing 8. The ring 4 protect that the balls 3 are moving radial by this axial force. Friction forces are created in the three contact points each ball has. Each ball 3 has a forced on rotation axis 6 and has contact points 7.1 and 7.2 at respective shaft 1 and 2.

At a turning of input shaft 1 then axis 6 at each ball 3 (which has a fix position with bearings (not included in this principal figure) and kept with an angle v) will rotate respective ball 3 from the points 7.1. Due to that the two points 7.1 and 7.2 are placed at different radial distances from respective rotation axis 6 the output shaft 2 will rotate with a different speed than input shaft 1. In that way you get a reduction ratio. The ring 4 rotates freely with a different speed.

If in the figure the angle v is 0 degrees then you get an eternal ratio, i.e. the output shaft 2 is not rotating.

This gear principle is used in for example the well known Kopp-variator, which has a mechanism for changing the angle v synchrony at all balls during running. In that way you get a stepless change of reduction ratio.

A proportional torque coupling is also used (not seen in this principal figure).

This type of gear is expensive and bulky especially if you only need a fixed ratio.

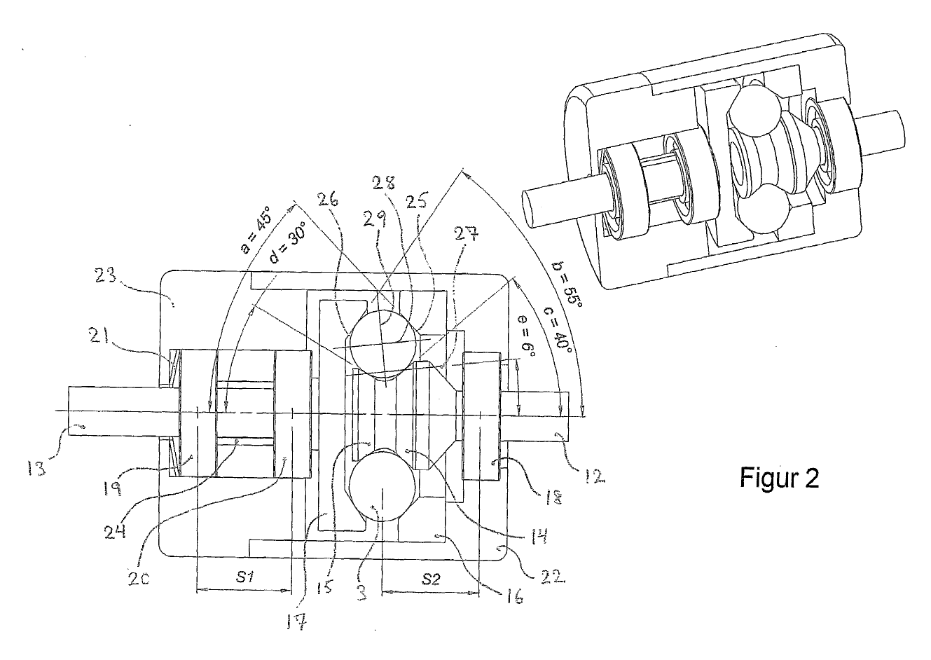

FIG. 2 shows a partly sectioned second well known ball friction gear which works at the following principle:

Input shaft 12 which has a ball bearing 18 has two raceways 14 and 15 which are tilted respective angle c and d in relation to the shaft 12 symmetry axis. Some balls 3, minimum 3 pcs, are running at these raceways and at the raceways at the rings 16 resp. 17 whose raceways are tilted the angle a respective b to its symmetry axis. Ring 16 is stationary and ring 17 is a part of output shaft 13 which has the ball bearing 19 and 20. A spring plate 21 push, via the ball bearing 19, the bearing distance 24 and the ball bearing 20 the shaft 13 with its ring 17 in direction to the stationary ring 16. So each of the balls 3 is loaded in four points. The angels a, b, c och d are different. Each ball 3 has contact points at the raceways 14, 15, 25 and 26. The connection line 27 through the contact points at the raceways 14 and 15 create the angle e with input shaft 12. Respective ball 3 will then both rotate around the axis 28 parallel to the line 27 and around one axis 29 perpendicular to 28. One important condition to get a good functioning ball friction gear is that no sliding occurs between the balls and the raceways. The spring plate 21 must give such a contact forces in these points so that together with the friction coefficient this will be avoided.

When the input shaft 12 is rotating the balls should run without sliding at all four raceways. To make this possible the output shaft 13 with its raceway 26 is forced to rotate.

The choice of angle a, b, c and d determine the reduced speed at output shaft 13, i.e. the reduction ratio.

It needs very small tolerances at the house 22 with its bearing plate 23 to get optimal contacts for the balls 3 to their raceways. An outer radial load at the input shaft 12 or at the output shaft 13 change the geometry for the gear and generate “micro-slip” and eventual also “macro-slip” (sliding).

FIG. 2 shows examples at values at the angles a, b, c and d.

Calculation of these angles as well as surface pressure, fatigue loads and more is done in Frej-Calc, a special designed computer program for this type of friction gears. This unique calculation method is outside this invention and will not be treated here.

NB If all parts in the gear is “perfect made” (no tolerances) and there is just one internal axial pre-load force, there is only one symmetric geometry which the moving gear parts will take after some turns of the input shaft.

The stiffness of the input shaft (together with the balls) is low against an outer disturbance torque perpendicular to the symmetry axis of the gear, depending on the small contact angles at the raceways.

One example at such a disturbance torque may be created from the coupling between the motor shaft and the input shaft.

The purpose and characteristics of the invention

The invention comprises of a new type of ball friction gear which:
1. is unsensitive to aiming errors of the output shaft.
2. is protected to overload torques at both the input and the output shafts.
3. transmits the motor torque even over all balls.
4. minimize “micro-slip”
5. consist of fewer parts than known designs.

These features are reached by a unique choice of geometry of the raceways and interacting shafts.

The invention lacks the drawbacks with other friction gears which have been described above.

The features of this new gear design can also be described as:

The gear accepts relative big angle change of the output shaft.

Sliding between the balls and the raceways will not occur at overload torque at either the input or the output shaft.

The gear will also work as a thrust bearing in linear actuators.

The gear will be simple and robust and have high efficiency, silent running, compact and suitable for mass production.

The basic gear principle should be in accordance to the earlier described gear in FIG. 2. See also the patent U.S. Pat. No. 3,955,661 (11 of May, 1976).

The performances of the invention are reached by the specific properties which are characterized part of the claim 1. Preferable variants are coupled to claim 1 together with some of the other claims.

### THE INVENTION IS DESCRIBED BELOW BY SUPPORT OF THE FOLLOWING FIGURES

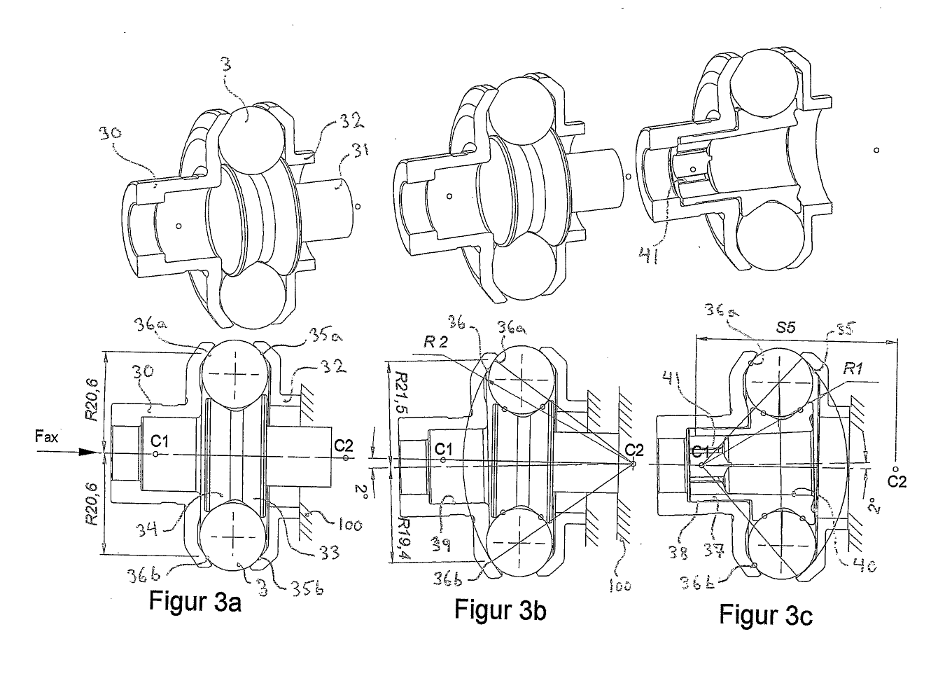

FIG. 3a shows the three central parts of the gear and the balls, all pressed axially to each other.

FIG. 3b shows the design according to FIG. 3a with the output shaft 30 tilted 2 degrees.

FIG. 3c shows the design according to FIG. 3a with all similar parts besides the ring 32 are tilted 2 degrees.

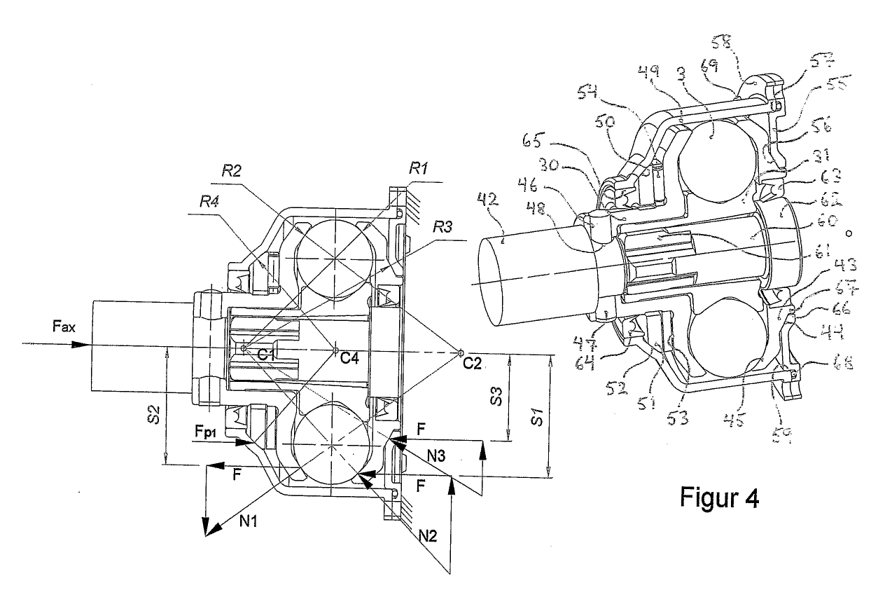

FIG. 4 shows a complete gear with internal pre-loading.

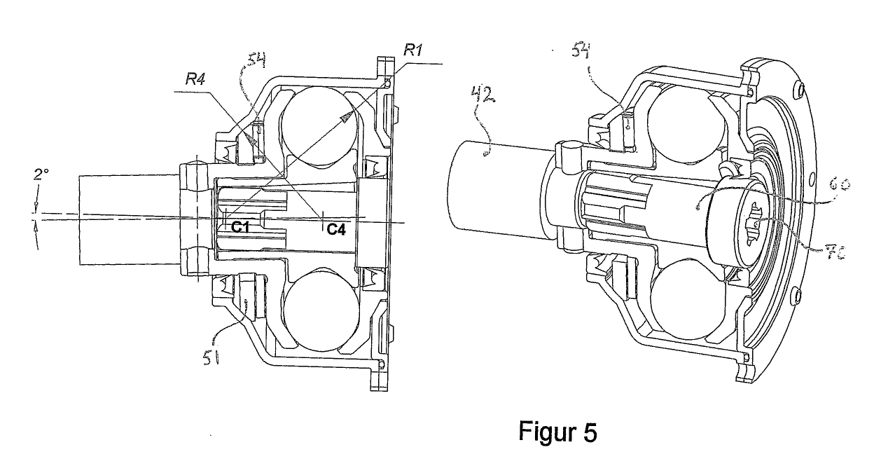

FIG. 5 shows the gear in FIG. 4 with the output shaft 42 tilted 2 degrees.

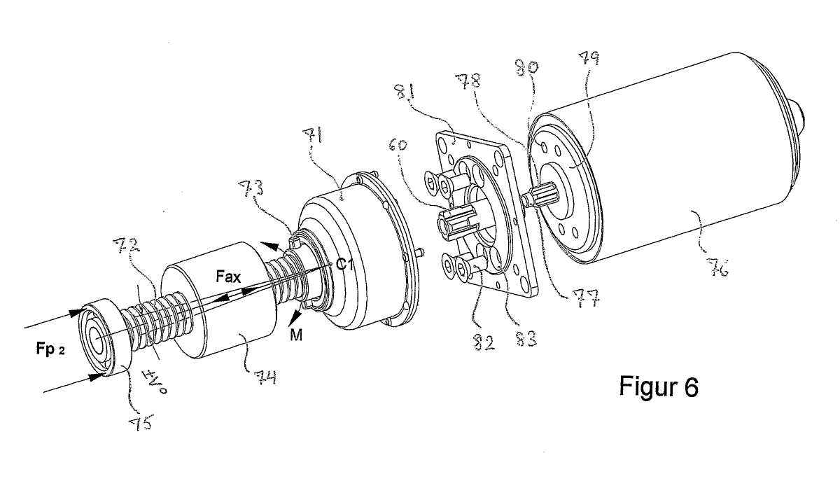

FIG. 6 shows an exploded view of the gear in FIG. 4 with motor and screw/nut mechanism.

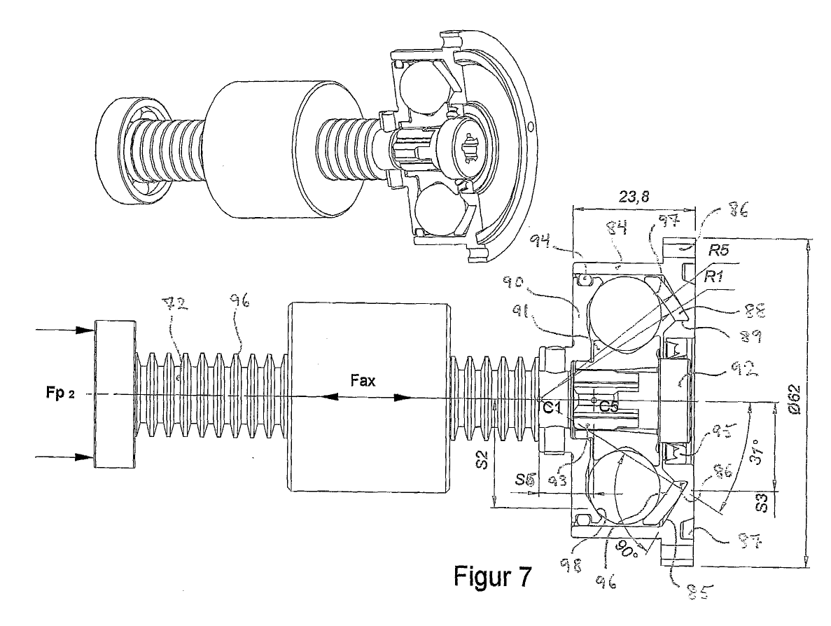

FIG. 7 shows a complete gear without internal pre-loading and with screw/nut mechanism.

### DETAILED DESCRIPTION OF THE FUNCTION OF THE INVENTION AND PREFERRED PERFORMANCES

In the following figures are shown forces between one ball and its contact points to the raceways in reality distributed similar to all balls.

For shown forces at the spherical or conical support surfaces is in reality even distributed forces over the rotation symmetrical contact surfaces.

The amount of balls is minimum 3 pcs and even distributed around the actual symmetry axis. The balls may have a ball cage according to well known technology or have no. If no cage the pitch diameter for the centre of the balls is so calculated that it is a little clearance between the balls when they are even distributed. In reality there are some point sliding contacts between the balls during running.

The below described flexible raceways are used in gears with normally more than 3 balls.

FIG. 3a

The ring 32 is here shown stationary fitted to the house 100 (in FIGS. 3a, 3b and 3c is it symbolic shown as a section line marking).

The symmetry axis for output shaft 30 is concentric with the ring 32.

The symmetry axis for input shaft 31 is concentric with the ring 32.

The axial force Fax is acting concentric at the output shaft 30.

The balls 3 are pushed against the spherical concave raceways 33 and 34 at the input shaft 31.

The balls 3 have contact points 35a resp. 35b at the spherical concave raceway at ring 32 which have the radius R1 with centre in the point C1 at the symmetric axis of the gear.

(The point C1 may also be defined as the point in which the prolonged connection line between resp. ball centre and its contact point at the raceway at the ring 32 hitting the symmetric axis of the gear. The point C2 can be defined in the same way.)

The balls 3 have also contact points 36a resp. 36b at the spherical concave raceway at the output shaft 30 which have the radius R2 with centre in the point C2 at the symmetric axis of the gear.

The contact points 36a and 36b have radial distances of R 20,6 mm from the symmetrical axis of the output shaft 30. See also FIGS. 3b and 3c.

Look at the gear as a geometrical figure in one plane, i.e. in the plane of the paper.

To make it easier to understand the geometrical condition let us assume that the two shown balls only can have these shown positions in relation to the input shaft 31, and for that reason are “welded” in their contact points to the input shaft 31. The input shaft 31 will act together with the balls as a stiff body. The theoretical “weldpoints” are marked with small circles in FIGS. 3b and 3c.

FIG. 3b

Assume that input shaft 31 (together with the balls) also is “welded” to the gear house 100.

If output shaft 30 is loaded by en outer radial force or a torque perpendicular to the papers plane, it will slide along the radius bow R2 with centre in C2. In the figure a counter clockwise turning of 2 degrees has been done.

The former contact points 35a, 35b, 36a, 36b remains at the balls. But the distances to the symmetry axis of the output shaft 30 for the points 36a and 36b have been changed to R21,5 resp. R19,4.

This means that a sliding occur in the gear when output shaft 30 1 rotated around point C2. The size of the sliding is direct coupled to the size of rotation.

FIG. 3c

Assume that input shaft 31 (together with the balls) instead is “welded” in the contact points 36a and 36b. If output shaft 30 is loaded once more by en outer radial force or a torque perpendicular to the papers plane, it will slide along the radius bow R1 with centre in C1. In the figure a counter clockwise turning of 2 degrees has been done.

The radial distance R20,6 has now not changed.

In practice to get the input shaft 31 together with the balls 3 to follow the output shaft 30 turning around the point C1, the input shaft 31 has got a cylindrical part 37 which at its outer left part has a short cylindrical guide surface 38 which fits with a small play in the cylindrical hole 39 in the output shaft 30.

The guide surface 38 is placed at a relative long distance S5 from the point C2, which gives an accurate angle guiding to the output shaft 30.

The input shaft 31 has in the figure got a going through the hole 40 instead for the former shown shaft tap.

The left part of the hole 40 has got an internal splines 41, i.e. some axial directed beams.

Point C1 defines the position of the gear. If there is no cylindrical part 37 (no guiding) small angle changing forces at the input shaft 31 will cause the output shaft 30 to turn around a point which differs in position from the point C1. Then a “micro-slip” occurs.

This invented gear accepts that the output shaft 30 change direction depending on outer forces or alignment error without destroying the gear geometry in accordance to FIG. 3a. This is necessary to avoid “micro-slip”. You can also express it as:

At an angle change of the output shaft 30, depending on misalignment or outer disturbing torques perpendicular to the shaft, also the input shaft 31 has to be changed the same angle. The centre for these changes has to be in the point C1 which is the centre of the spherical raceway 35.

FIG. 4

The figure shows a sectioned complete gear according to the invention. The gear has internal pre-load, which allows the output shaft 30 to take outer loads in all shaft directions as axial forces from a screw mechanism, radial forces or torques.

The former ring 32 is here replace by the ring 43 which have a spherical surface 44 with a radius R3 and have a spherical raceway 45 with radius R1 and centre C1. Output shaft 30 has got a radial hole 46. An output tap 42 is fitted to output shaft 30 by a cylindrical pin 47 which is placed in the hole 46 and in a hole 48 at the output tap 42. The house 49 has en internal shaped spherical surface 50. Against this surface is a flat bearing ring 51 with a spherical backside surface 52 is pushed. The spherical surfaces 50 and 52 have both the radius R4 and centre C4. Between the bearing ring 51 and the flat surface 53 at the output shaft 30 is a cylindrical thrust roller bearing 54 placed. A spring plate 55, which have a spherical surface 56 with radius R3 and centre C1 and one with this concentric fitting 57 which fits in a fitting 59 in the house 49, is with rivets 57 attached to the flange 58 at the house 49.

A coupling shaft 60, placed in the hole 40, has at its left end some outer placed axial directed crowned beams 61 which with smoothness are meshing the internal splines 41. In the right en of the coupling shaft 60 there is a cylindrical surface 62.

The gear according to the invention is sealed by two radial sealings 63 and 64 which seals against the surface 62 at the coupling shaft 60 resp. the surface 65 at the output shaft 30. An O-ring 68 seals between the house 49 and the spring plate 55.

The ring 43 can move freely around the centre point C1 within an angle range limited of the radial play between the cylindrical hole 66 in the spring plate 55 and the outer surface at the cylindrical part 67 at the ring 43.

The gear in the FIG. 4 is loaded by two axial forces Fp and Fax.

The force Fp is created by the spring plate 55, preferably made in spring steel and fixed by rivets 69 to the flange 58 and in that way axial flexible and then pre-loading all ball contacts points, the thrust bearing 54 and the spherical surfaces 44 and 56 as well as 50 and 52.

The outer force Fax is concentric with the symmetry axis of output tap 42.

The sum of these forces is the force F.

When the size of the outer force Fax has increased to the same value as the pre-loading force Fp the thrust bearing 54 has been unloaded and the force F=Fax.

The feature with this preloading system is that the axial load at the balls and the raceways will never be bigger than the outer force Fax.

If the outer axial force Fax has contrary direction the pre-loading force Fp over the balls and raceways will be constant and will define the size of the maximum transmitted torque in the gear. This concerns if the house 49 is much axial stiffer (higher spring constant) than the spring plate 55 is.

The FIG. 4 shows the forces N1 and N2 which creates in the ball contact points and the force N3 in the spherical support surface. The forces between the balls and the raceways at the input shaft 31 in not shown in the figure.

The maximum possible torque which can be transited to the output tap 42 defines of the tangential directed friction force multiplied by the radial distance to the symmetry axis of the output tap 42. You can with good accuracy assume that there is the same friction coefficient value in all contact points and surfaces in the gear. Sliding will occur in the contact point/surface which gives the lowest friction torque.

There are five different friction torques:

M1=N1×S1×my

M2=N2×S2×my

M3=N3×S3×my

M4=N4×S4×my (not shown in the figure)

M5=N5×S5×my (not shown in the figure)

(my=friction coefficient)

The friction torqueses above are calculated in the former mentioned computer program Frej-Calc.

Sliding between the balls and the raceways at the input shaft 31 will never occur because the friction torque is the sum of the two raceways 33, 34 friction torques M4 and M5 and is therefore always bigger than biggest of M1, M2 and M3.

The lowest of these torques is M3. At an outer overload torque at the output tap 42 a sliding will occur between the spherical surfaces 44 and 56.

A sliding between the balls and the raceways should very quickly destroy them, the sound level should increase and the life time for the gear should be dramatically shortened. Now the sliding at overload occurs between the surfaces 44 and 56 independently of the size of the preloading force Fp and the outer load Fax. The size of the torque M3 in relation to M1 and M2 is possible to adjust by changing the size of the radius S3 (and thus also N3) or by adjusting the friction coefficient between the cooperation surfaces 44 and 56 which can be made by changing the surface quality or by electro plating the surfaces by for example copper.

As mentioned earlier the demand for this gear principle is that either the output shaft 30 or the ring 43 must accepts to rotate. Otherwise a sliding occurs between the balls 3 and the raceways.

At a sudden blocking or other type of acceleration/retardation at the output tap 42, a dynamic torque creates, depending on the ertia of the motor rotor, which can be bigger than the friction torque M3. The ring 43 starts rotating and is then acting as an overload coupling. This function will also act if the torque is bigger than M3. With other word, the maximum motor torque transmitted to the output tap 42 should be lower than M3. This demand is valid only if the output tap 42 is loaded by a torque and when the force Fax is smaller than Fp or is negative i.e. directed to the left in the figure.

If Fax is bigger than Fp (and directed to the right in the figure) the sliding torque M3 increase proportional with Fax. But the relation to the other friction torques remains.

FIG. 5

The figure shows the sectioned gear in FIG. 4 but here the output tap 42 is tilted two degrees around the centre point C1. Then the bearing ring 51 and the thrust roller bearing 54 has to be tilted the same angle around the centre point C4 which is centre point for the spherical surface 52 at the bearing ring 51. The points C1 and C4 are placed at different positions at the symmetry axis of the gear. Then the thrust roller bearing 54 has also to make a translation movement mainly in a plane perpendicular to the symmetry axis of the output tap 42. The thrust roller bearing 54, which consists of a roller cage, normally in plastic, with a bigger amount of radial aimed rectangular holes with steel rollers, is a commercial type of bearing which is intended to accept such radial movements. The load capacity of such a bearing is high compared to the loads Fax and Fb.

The figure shows also the coupling shaft 60, preferable made of moulded plastic, with its internal splines 70 to which the external crowned splines 78 at the motor shaft 77 (see FIG. 6) fits with a smooth fitting.

FIG. 6

The figure shows an exploded view of the gear 71 where the output tap 42 has been replaced by a screw 72 and the former cylindrical pin 47 replaced by a spring pin 73. At the screw 72 there is a nut 74, often made of plastic. In the other outer end of the screw 72 there is a ball bearing 75.

The figure shows also the motor 76 with its motor shaft 77 with crowned splines 78 and with its motor gavel 79 with threads 80.

The adapter plate 81 is equipped with holes 83. Screws 82 fit this to the motor gavel 79.

The figure shows also the coupling shaft 60.

The screw 72 allows moving around centre point C1 within a conical angle +/−V degrees both when the gear is rotating and when it has stopped.

The gear behaves as a spherical ball bearing which allows self-alignment, a feature which is of great interest in many applications.

At a rotating gear this movement occur when the balls is running at the raceway at the ring 43 without any sliding.

At a non-rotating gear a sliding may occur but this will normally not affect the surfaces.

The ball bearing 75 may be needed as a radial support if the screw 72 is long or if the nut 74 has no radial sliding support.

The axial force Fp2 which adds to the outer ring of the ball bearing 75 will sometimes be needed to increase the pre-loading of the gear to be able to transmit higher torque.

FIG. 7

The figure shows a complete gear with no internal pre-loading but with a screw mechanism.

The screw 72 with its thread 96 is here shown in a simplified shape without pitch.

A line, perpendicular against and on a conical surface 85 in the house 84 and at a distance S3 from the symmetry axis of the gear, hits the centre point C1. The house 84 has also one with the surface 85 concentric cylindrical surface 86.

The house 84 has some axial aimed fitting holes 86 and one with the cylindrical surface 86 concentric hole 87 which is used as a guide for the motor or adapter flange.

A ring 88 has a spherical raceway 96 with radius R1 and an outer spherical surface with radius R5. Both these radius have the same centre C1. The ring 88 has a cylindrical internal surface 89 which fits to the cylindrical surface 86 with a certain little radial play.

The output shaft 90 corresponds to the earlier output shaft 30 but has been made a little shorter.

The input shaft 91 corresponds to the earlier input shaft 31 but has been made a little shorter. The earlier internal splines 41 is here moved to centre point C5.

The coupling shaft 92 corresponds to the earlier coupling shaft 60 but has been made a little shorter. The centre of the external crowned splines 93 is placed in point C5.

An o-ring 94 and a radial sealing 95 are sealing the gear.

The screw mechanism corresponds to the earlier one described in FIG. 6.

Because the gear has no internal pre-load then an outer preload Fp2 can be added by a spring acting at the outer ring of the ball bearing.

If the force Fax at the nut is aimed to the left in the figure, then Fp2 must be not only as big as Fax but also be able to give enough pre-load to deliver the torque the screw needs.

If the force Fax is aimed to the right and is a gravitation force, then no pre-load Fp2 needs if the theoretical gear solution meet the criteria of freedom from sliding is fulfilled in the earlier mentioned program Frej-Calc.

In this gear alternative design the internal splines 41 at the input shaft 31 is placed in the centre point C5, at a distance S6 from C1. At a tilting V degrees the splines 41 will move radial r=S6×tan V. The coupling shaft 60 has bow gear coupling functions in both ends, i.e. it will act like a shaft with universal joint in each ends. There must be fi-ee space for radial movement r.

The ring 88 has been made relatively thin for two reasons:

First the ring is a little elastic which secure that all balls will have nearly the same contact forces and then give the same friction torque. Manufacturing tolerances will then be eliminated.

Secondly the axial load Fax gives an elastic torsion of the ring. You can look at the ring 88 as a spring plate. At this torsion the ball contact angle will change at the raceway 96 and this will change the reduction ratio in the gear. At an increase of the axial load Fax when this is aimed to the right in the figure the radius R1 will increase. The centre point C1 is moving to the left in the figure. The ball contact angle will get closer to corresponding angle at the raceway 98. A calculation shows that for about 4 degrees torsion the reduction ratio will increase about 25%.

The basic condition is that the output shaft 90 is much stiffer than the ring 88.

Such an increase in reduction ratio can be of interest in many applications for example to temporarily increase the gear torque at the output shaft 42 i.e. the screw 72 to overcome the static friction before the movement (dynamic friction) enters.

The flexibility in the raceways ball contact points, the spring coefficient in the spring plate 55 and in the ring 88 can be defined with high accuracy by a FEM-calculation (Finite Element).

To increase the friction coefficient in the ball contact points a special type of grease or oil for friction gears can be used which have the characteristic that the viscosity increase momentarily when the pressure increase at the lubrication in the ball contact points. During the solidifying process the friction coefficient increase which increase the maximum possible transmitted torque in the gear.

### Possible Alternative Designs Based on the Invention.

The first performance of the invention concerns a ball friction gear with an output shaft which is loaded by an external force mainly aimed against the gear and then the gear itself constitute as a thrust bearing. The output shaft allows changing direction in relation to the gear without affecting the efficiency of the gear worth mentioning. The gear is protected against sliding between the balls and the raceways by the ring 43, 88 which is acting as a slide coupling by its fitting to the gear house.

At least one of the raceways has some flexibility and then ensures that all balls will transmit about the same friction torque.

The second performance of the invention concerns a ball friction gear according to the first performance where the output shaft which can take external loads in all directions by adding a thrust bearing 54 in the gear which allows that an internal spring pre-loading can been created over the balls and the raceways.

The third performance of the invention concerns a ball friction gear according to the first and second performances where the ring 32, 43, 88 or the output shaft 30, 90 is flexible for torsion which gives an automatic change in the reduction ratio in the gear at a change in an outer axial load.

The fourth performance of the invention concerns a ball friction gear according to the first, second and third performances where at least one raceway has spherical surface.

The fifth performance of the invention concerns a ball friction gear according to the first, second and third performances where one raceway has spherical surface and at least one of the other raceways has conical surface.

1. A friction gear to transmit torque consisting of an input shaft (31) provided with to each other directed tilted raceways (33) and (34), one to a gear house (100) fitted ring (32) provided with a raceway (35), one output shaft (30) provided with a raceway (36), all of them symmetrical and concentrically placed, and at least three balls (3) and two towards each other axial directed forces pushing the raceways (35) and (36) against the balls (3) which then will be pushed against the raceways (33) and (34) characterized in that the raceway (35) is spherical, that the symmetry axis of the input shaft (31) is so arranged that it always mainly coincides with the symmetry axis of the output shaft (30), that the centre of gravity of all balls (3) are moving in a common plane mainly perpendicular to the symmetry axis of the output shaft (30) which allows changes in angle attitudes of the symmetry axis of the output shaft (30) without causing any change in the geometry between the normally moving gear components (30), (31), (3) and that the normally not rotating ring (32) allows for certain torques to rotate its support fitting in the house (100).

2. A mechanism according to claim 1, characterized in that one or more of the raceways (33), (34), (36) are spherical.

3. A mechanism according to claim 1 and claim 2, characterized in that the ring (32, 88) has a spherical support surface which is supported at a conical or spherical surface (85) in a gear house (100, 84).

4. A mechanism according to claim 1, characterized in that the input shaft (31, 91) has a cylindrical axial directed part (37) which has at its outer end a short bearing surface (38) which with a small play fits in a cylindrical hole (39) at the output shaft (30, 90) and then force the input shaft (31, 91) and the balls (3) in its common plane of gravity to turn around a point (C1), which is the centre for the spherical raceway (35), at an angle attitude change of the output shaft (30, 90).

5. A mechanism according to claim 1, characterized in that the ring (32, 43, 88) has a spherical raceway (35, 45, 96) with radius R1 with centre in C1 and its backside has a spherical surface with radius R5 with its centre close to C1 and which is radial guided by in the gear house (100, 84) short cylindrical surface (86) and at an axial conical or spherical surface (85) with its radial contact position S3 so choosen that a sliding only occur in this contact circle when the outgoing shaft (30, 90) is loaded with a certain high torque around its symmetry axis.

6. A mechanism according to claim 5, characterized in that at an outer axial force, aiming against the gear, makes a distortion of the ring (32, 43, 88) which changes the ball contact angle of the raceway (35, 96) which changes the reduction ratio in the gear.

7. A mechanism according to claim 1, characterized in that the ring (32, 43, 88) has a spherical backside surface (44) with radius R3 with its centre close to C1 and axially supported at a spherical surface (56) at a spring plate (55) which is fitted to the gear house (100, 49) in such a manner that the spring plate (55) is axial elastic deflected and then gives the desired internal preloading when the reaction force is taken up by a thrust bearing (54) with its raceways consisting of a bearing plate (51) with its spherical support surface (52) which is in contact with a local spherical surface (50) in the gear house (100, 49) and of a surface (53) at the output shaft (30) thus accepting a self positioning by a combination of turning and radial translation of the thrust bearing (54) when a change in angle attitudes of the output shaft (30, 90) occur.

8. A mechanism according to claim 1, characterized in that the input shaft (31) has internal splines (41) in the hole (40) which serve as one part of a bow coupling together with some corresponding crowned beams (61) at a coupling shaft (60) and that these splines (41) should be placed as close as possible to the point C1 to minimize the created radial aiming translation movement when a change in angle attitude of the output shaft (30, 90) occur and thus also the input shaft (31,91).

9. A mechanism according to claim 1, characterized in that one or more of mentioned raceways for the balls (3) are slightly elastic to secure that all ball contacts will take nearly the same load and will reduce the sound level.
